(19) United States
(12) Patent Application Publication
(10) Pub. No.: US 2008/0299366 A1
(43) Pub. Date: Dec. 4, 2008

(54) CEMENTED CARBIDE INSERT

(75) Inventors: Mats Ahlgren, Taby (SE); Susanne Norgren, Huddinge (SE); Anders Nordgren, Enskede (SE); Ann-Britt Ljungberg, Stockholm (SE); Anders Jonsson, Gavle (SE); Ann-Marie Malm, Sandviken (SE); Bo Blom, Gimo (SE); Martin Hansson, Gavle (SE)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB, Sandviken (SE)

(21) Appl. No.: 12/126,195

(22) Filed: May 23, 2008

(30) Foreign Application Priority Data
Jun. 1, 2007 (SE) 0701320-4
Jun. 15, 2007 (SE) 0701449-1
Jun. 27, 2007 (SE) 0701548-0
Jul. 23, 2007 (SE) 0701760-1

(51) Int. Cl. B32B 7/00; B22F 3/12

(52) U.S. Cl. 428/216; 419/18; 82/1.11

(57) ABSTRACT

The present invention relates to a cutting tool insert for parting, grooving and threading in steel and stainless steels comprising a substrate and a coating. The substrate comprises WC, from about 7.5 to about 10.5 wt-% Co, from about 0.7 to about 1.1 wt-% Cr and from about 100 to about 300 ppm Ti. Ti may partly be replaced by Ta to a weight ratio Ti/Ta of equal to or more than about 0.8. The coating comprises two (Ti,Al)N-layers with different Al/Ti-ratios: an inner Al_{y}Ti1-yN-layer with y equals from about 0.4 to about 0.67 with a thickness of from about 0.3 to about 2.5 μm and an outer Al_{w}T_{1-w}N layer with w equals from about 0.15 to about 0.35 with a thickness of from about 0.5 to about 5.0 μm.

### BACKGROUND OF THE INVENTION

The present invention relates to a coated cutting tool insert particularly useful for parting, grooving and threading in steel, stainless steels and heat resistant superalloys (HRSA) under wet conditions. A multilayered PVD-coating greatly improves the flank wear resistance and a high chromium fine grained substrate provides good resistance against plastic deformation.

Coated cutting tool inserts for parting, grooving and threading in a big variation of work materials as steel, stainless steels and HRSA must have the following properties:

1. High resistance against plastic deformation, since the cutting process generates a high temperature in the cutting edge of the insert, especially in the nose area when threading.

2. Good resistance against abrasive wear in order to avoid a rapidly growing flank wear.

3. Good resistance against adhesion wear and very good adhesion between the substrate and the coating. The chips from especially stainless steels are very prone to welding onto the surface of the insert.

4. Good edge line toughness in order to avoid breakage and chipping.

5. Good bulk toughness in order to avoid bulk breakage especially when cutting off to centre.

U.S. Pat. No. 6,261,673 discloses a coated cemented carbide insert useful for grooving or parting of steel components such as steel or stainless steel tubes and bars. The insert is characterized by a WC-Co-based cemented carbide substrate having a highly W-alloyed Co-binder phase and a relatively thin coating including an inner layer of TiCₓN_{y}O_{z} with columnar grains followed by a layer of fine grained κ-Al₂O₃ and a top layer of TiN.

U.S. Pat. No. 6,342,291 discloses a coated cutting tool useful for grooving or parting of steel components such as steel or stainless steel tubes and bars. The insert is characterized by a WC-Co-based cemented carbide substrate having a highly W-alloyed Co-binder phase and a hard and wear resistant coating including a multilayered structure of sublayers of the composition (TiₓAl_{1-w})N with repeated variation of the Ti/Al ratio.

EP-A-1798310 discloses a cutting insert for parting and grooving in heat resistant superalloys and stainless steels comprising a substrate and a coating. The substrate comprises from about 5 to about −7 wt-% Co, from about 0.15 to about 0.60 wt-% TaC, from about 0.10 to about 0.50 wt-% NbC and balance WC. The coating consists of a homogeneous AlₓTi₁₋ₓN-layer with x equals from about 0.6 to about 0.7 and a thickness of from about 1 to about 3.8 μm.

### OBJECTS AND SUMMARY OF THE INVENTION

It is an object of the present invention to provide a cutting tool insert useful for parting, grooving and threading in steel, stainless steels, and HRSA, under wet conditions.

It is a further object of the present invention to provide a cutting tool insert with improved resistance against plastic deformation and wear resistance.

It is yet a further object of the present invention to provide a cutting tool where the improved resistance against plastic deformation has not been obtained at the expense of lowered edge line toughness.

In one aspect of the invention, there is provided a cutting tool insert comprising a substrate and a coating, wherein the substrate comprises WC, from about 7.5 to about 10.5 wt-% Co, from about 0.7 to about 1.1 wt-% Cr and from about 100 to about 300 ppm Ti, with a CW_Cr-ratio of from about 0.77 to about 0.97, and a coercivity of from about 21 to about 27 kA/m, the CW_Cr ratio being defined as CW_Cr=(magnetic-% Co+1.13*wt-% Cr)/wt-% Co, where magnetic-% Co is the weight percentage of magnetic Co, wt-% Cr is the weight percentage of Cr in the cemented carbide and wt-% Co is the weight percentage of Co in the cemented carbide, and, the coating comprises two (Ti,Al)N-layers with different Al/Ti-ratios: an inner Al_{y}Ti_{1-y}N-layer with y equal from about 0.4 to about 0.67, with a thickness of from about 0.3 to about 2.5 μm, and an outer Al_{w}T_{1-w}N layer with w equal from about 0.15 to about 0.35, with a thickness of from about 0.5 to about 5.0 μm.

In another aspect of the invention, there is provided a method of making a coated cutting tool insert comprising a cemented carbide substrate and a coating, comprising the following steps: providing a substrate using conventional powder metallurgical techniques milling, pressing and sintering, of WC, from about 7.5 to about 10.5 wt-% Co, from about 0.7 to about 1.1 wt-% Cr, and from about 100 to about 300 ppm Ti, with a CW_Cr-ratio of from about 0.77 to about 0.97, and a coercivity of from about 21 to about 27 kA/m, the CW_Cr ratio being defined as CW_Cr=(magnetic-% Co+1.13*wt-% Cr)/wt-% Co where magnetic-% Co is the weight percentage of magnetic Co, wt-% Cr is the weight percentage of Cr and wt-% Co is the weight percentage of Co in the cemented carbide, and, depositing using cathodic arc evaporation or magnetron sputtering a coating comprising two (Ti,Al)N-layers with different Al/Ti-ratios: an inner Al_{y}Ti_{1-y}N-layer with y equals from about 0.4 to about 0.67, with a thickness of from about 0.3 to about 2.5 μm and an outer Al_{w}T_{1-w}N layer with w equals from about 0.15 to about 0.35, with a thickness of from about 0.5 to about 5.0 μm.

In still another aspect of the invention, there is provided a method of parting, grooving and threading in steel and stainless steel under wet conditions at a cutting speed of from about 30 to about 400 m/min and a feed of from about 0.05 to about 0.6 mm/rev, using a cutting tool insert comprising a substrate and a coating, wherein the substrate is WC, from about 7.5 to about 10.5 wt-% Co, from about 0.7 to about 1.1 wt-% Cr and from about 100 to about 300 ppm Ti, with a CW_Cr-ratio of from about 0.77 to about 0.97, and a coercivity of from about 21 to about 27 kA/m, the CW_Cr ratio being defined as CW_Cr=(magnetic-% Co+1.13*wt-% Cr)/wt-% Co, where magnetic-% Co is the weight percentage of magnetic Co, wt-% Cr is the weight percentage of Cr in the cemented carbide and wt-% Co is the weight percentage of Co in the cemented carbide, and, the coating comprises two (Ti,Al)N-layers with different Al/Ti-ratios: an inner Al_{y}Ti_{1-y}N-layer with y equals from about 0.4 to about 0.67, with a thickness of from about 0.3 to about 2.5 μm, and an outer Al_{w}Ti_{1-w}N layer with w equals from about 0.15 to about 0.35, with a thickness of from about 0.5 to about 5.0 μm.

### DETAILED DESCRIPTION OF THE PREFERRED EMBODIMENTS

It has now been found that a multilayered (Ti,Al)N PVD-coating in combination with a high chromium, fine grained substrate provides good resistance against plastic deformation, good wear resistance and sufficient edge line toughness when parting, grooving and threading under wet conditions in steel, stainless steels and HRSA.

The present invention thus relates to a coated cutting tool insert comprising a cemented carbide substrate and a coating. The cemented carbide substrate comprises WC, from about 7.5 to about 10.5 wt-% Co, preferably from about 8.0 to about 10.0 wt-% Co, most preferably from about 8.5 to about 9.5 wt-% Co, and from about 0.7 to about 1.1 wt-% Cr, preferably from about 0.8 to about 1.0 wt-% Cr. The cemented carbide further contains from about 100 to about 300 ppm Ti, preferably from about 150 to about 275 ppm Ti, most preferably from about 200 to about 260 ppm Ti. In another embodiment, a part of the Ti is replaced by Ta with a weight ratio Ti/Ta of more than or equal to about 0.8, preferably less than or equal to about 1.7, most preferably from about 1.2 to about 1.5.

The binder phase is alloyed with W and Cr which influences the magnetic properties of the binder and can hence be related to a value, CW_Cr ratio, defined as

CW_Cr=(magnetic-% Co+1.13*wt-% Cr)/wt-% Co

where magnetic-% Co is the weight percentage of magnetic Co, wt-% Cr is the weight percentage of Cr in the cemented carbide and wt-% Co is the weight percentage of Co in the cemented carbide.

It has been found that improved cutting performance is achieved if the cemented carbide has a CW_Cr-ratio of from about 0.77 to about 0.97, preferably from about 0.80 to about 0.94, most preferably from about 0.82 to about 0.92 and a coercivity of from about 21 to about 27 kA/m, preferably from about 22 to about 26, kA/m.

The sintered body may also contain small amounts of precipitations of additional phase or phases such as eta-phase, MX or M₇X₃, M₃X₂ where M=(Ti+Ta+Co+Cr+W) with X═C or N, and may be allowed to a volume fraction of maximum about 0.5 vol-% without detrimental effects.

The coating comprises two (Ti,Al)N-layers with different Al/Ti-ratios. The inner layer has a higher Al/Ti-ratio than the outer layer. The inner layer is an Al_{y}Ti_{1-y}N-layer with y equals from about 0.4 to about 0.67, preferably from about 0.45 to about 0.60. The coating thickness of the inner layer is from about 0.3 to about 2.5 μm, preferably from about 0.5 to about 2.0 μm. In one preferred embodiment, the inner layer is an aperiodic lamella coating of alternating layers of Al_{z}Ti_{1-z}N and AlᵥTi₁₋ᵥN where z equals from about 0.55 to about 0.70, preferably z equals from about 0.6 to about 0.67, and v equal from about 0.35 to about 0.53, preferably v equal from about 0.40 to about 0.50. The coating thickness of each individual layer is from about 0.1 to about 20 nm, preferably from about 1 to about 10 nm. The outer layer is an Al_{w}Ti_{1-w}N layer with w equals from about 0.15 to about 0.35, preferably w equals from about 0.20 to about 0.30. The coating thickness of the outer layer is from about 0.5 to about 5.0 μm, preferably from about 1.0 to about 4.0 μm. In one preferred embodiment, the outer layer is an aperiodic lamella coating with alternating layers of AlₘTi₁₋ₘN, AlₙTi₁₋ₙN and AlₖTi₁₋ₖN where m equals from about 0 to about 0.2, preferably m equals from about 0 to about 0.1, n equals from about 0.35 to about 0.53, preferably n equals from about 0.40 to about 0.50, k equals from about 0.55 to about 0.70, preferably k from about 0.6 to about 0.67. The coating thickness of each individual layer is from about 0.1 to about 20 nm, preferably from about 1 to about 10 nm. The total thickness of the coating is from about 0.8 to about 7.5 μm, preferably from about 1.5 to about 6.0 μm. The thickness of the individual layers is measured on the flank face about 0.2 mm below the cutting edge.

In one preferred embodiment, the coating has an innermost adhesion layer of a TiN-layer, with the thickness of from about 0.05 to about 0.2 μm, preferably from about 0.1 to about 0.2 μm.

In one embodiment, the coating has a top layer of TiN for color purpose. The thickness of the TiN-layer is from about 0.1 to about 1 μm, preferably from about 0.1 to about 0.3 μm.

In another embodiment, the coating has a top layer of AlₚTi₁₋ₚN for color purpose with p equals from about 0.05 to about 0.67. The thickness of the AlₚTi₁₋ₚN-layer is from about 0.2 to about 1 μm, preferably from about 0.2 to about 0.4 μm.

The present invention also relates to a method of making a coated cutting tool insert comprising a cemented carbide substrate and a coating. The cemented carbide substrate is made using conventional powder metallurgical techniques milling, pressing and sintering. The cemented carbide substrate comprises WC, from about 7.5 to about 10.5 wt-% Co, preferably from about 8.0 to about 10.0 wt-% Co, most preferably from about 8.5 to about 9.5 wt-% Co and from about 0.7 to about 1.1 wt-% Cr, preferably from about 0.8 to about 1.0 wt-% Cr. In one embodiment, the cemented carbide further contains from about 100 to about 300 ppm Ti, preferably from about 150 to about 275 ppm Ti, most preferably from about 200 to about 260 ppm Ti. In another embodiment, a part of the Ti is replaced by Ta with a weight ratio Ti/Ta of equal to or more than about 0.8, preferably equal to or less than about 1.7, most preferably from about 1.2 to about 1.5, added as TaC,(Ta,W)C, TiC,(Ti,W)C and/or (Ti,Ta,W)C and combinations of these. After sintering in vacuum for 1 hour at 1410° C. the coercivity is from about 21 to about 27 kA/m, preferably from about 22 to about 26 kA/m.

The CW_Cr-ratio is from about 0.77 to about 0.97, preferably from about 0.80 to about 0.94, most preferably from about 0.82 to about 0.92, and is monitored by adding suitable amounts of carbon black or tungsten powder to the powder mixture.

After conventional post sintering treatment, the coating comprises two (Ti,Al)N-layers with different Al/Ti-ratios are deposited with cathodic arc evaporation or magnetron sputtering. The inner layer has a higher Al/Ti-ratio than the outer layer. The inner layer is an Al_{y}Ti_{1-y}N-layer where y equals from about 0.4 to about 0.67, preferably from about 0.45 to about 0.60. The coating thickness of the inner layer is from about 0.3 to about 2.5 μm, preferably from about 0.5 to about 2.0 μm. In one preferred embodiment, the inner layer is an aperiodic lamella coating of alternating layers of Al_{z}Ti_{1-z}N and AlᵥTi₁₋ᵥN where z equals from about 0.55 to about 0.70, preferably z equals from about 0.6 to about 0.67 and v equals from about 0.35 to about 0.53, preferably v from about 0.40 to about 0.50. The coating thickness of each individual layer is from about 0.1 to about 20 nm, preferably from about 1 to about 10 nm. The outer layer is of an Al_{w}Ti_{1-w}N layer with w equals from about 0.15 to about 0.35, preferably w equals from about 0.20 to about 0.30. The coating thickness of the outer layer is from about 0.5 to about 5.0 μm, preferably from about 1.0 to about 4.0 μm. In one preferred embodiment, the outer layer is an aperiodic lamella coating with alternating layers of AlₘTi₁₋ₘN, AlₙTi₁₋ₙN and AlₖTi₁₋ₖN where m equals from about 0 to about 0.2, preferably m equals from about 0 to about 0.1, n equals from about 0.35 to about 0.53 preferably n equals from about 0.40 to about 0.50, k equals from about 0.55 to about 0.70, preferably k equals from about 0.6 to about 0.67. The coating thickness of each individual layer is from about 0.1 to about 20 nm, preferably from about 1 to about 10 nm. The total thickness of the coating is from about 0.8 to about 7.5 μm, preferably from about 1.5 to about 6.0 μm.

The present invention also relates to the use of the insert as described above for parting, grooving and threading under wet conditions in steel and stainless steels at a cutting speed of from about 30 to about 400 m/min and a feed of from about 0.05 to about 0.6 mm/rev and in HRSA at a cutting speed of from about 15 to about 100 m/min and a feed of from about 0.02 to about 0.3 mm/rev.

The invention is additionally illustrated in connection with the following examples, which are to be considered as illustrative of the present invention. It should be understood, however, that the invention is not limited to the specific details of the examples.

### Example 1

### Invention

A1. A multilayer (Ti,Al)N-coating was deposited by cathodic arc evaporation on cutting inserts made of cemented carbide with a composition of 9 wt-% Co, 0.9 wt-% Cr, 230 ppm Ti and balance WC and a coercivity of 23.6 kA/m corresponding to an average grain size of about 0.8 μm and a magnetic Co-content of 6.7 corresponding to a CW_Cr-ratio of 0.95. The coating was deposited using arc evaporation of Ti and TiAl metal sources. A TiN adhesion layer was deposited using Ti metal sources in a mixed Ar and N₂ atmosphere. The coating thickness of the TiN adhesion layer was 0.15 μm. A second layer was deposited in a N₂ atmosphere using targets of Al_{0.67}Ti_{0.33} and Al_{0.05}Ti_{0.50} alloy. An aperiodic lamella structure was obtained by a 3-fold rotation of the inserts inside the deposition chamber. The thickness of the second layer was 1.6 μm. The average composition was Al_{0.54}Ti_{0.46}N as determined by SEM-EDS. The average thickness of the individual lamella layers of the second layer was 8 nm as determined by transmission electron microscopy (TEM). The third outer layer was deposited in a N₂ atmosphere using targets of Ti, Al_{0.67}Ti_{0.33} and Al_{0.50}Ti_{0.50} alloy. An aperiodic lamella structure was obtained by a 3-fold rotation of the inserts inside the deposition chamber. The thickness of this third layer was 2.6 μm. The average composition of the third layer was Al_{0.24}Ti_{0.76} as determined by SEM-EDS. The average thickness of the individual lamella layers of the third layer was 11 nm as determined by TEM. The total thickness of the applied coating was 4.4 μm.

A2. The same coating as in A1 was deposited on a cemented carbide with a composition of 9 wt-% Co, 0.9 wt-% Cr, 130 ppm Ti, 100 ppm Ta and balance WC.

### Example 2

### Prior Art

B. Cemented carbide grooving inserts composed of a cemented carbide substrate of 10 wt-% Co, 0.39 wt-% Cr and balance WC with a coercivity of 20 kA/m and a CW_Cr of 0.89 corresponding to a grain size of 0.9 μm and a hardness of 1600 HV3 were coated with a 4.4 μm PVD (Ti,Al)N multilayer of a sequence of homogeneous Al_{0.5}Ti_{0.5}N layers and lamella layers with alternating layers of TiN and Al_{0.5}Ti_{0.5}N. This sequence was repeated twelve times. The thickness of the homogeneous Al_{0.5}Ti_{0.5}N-layers was 0.1-0.2 μm and the thickness of the la-mella layers was 0.1-0.2 μm. The thickness of each individual TiN or Al_{0.5}Ti_{0.5}N-layer in the lamella layer was 0.1-20 nm. The average composition of the multilayer was Al_{0.2}Ti_{0.8}N measured with SEM-EDS.

### Example 3

Inserts A1 and B were tested in grooving and turning of a quenched and tempered steel component. The first operation is a 2 mm deep groove from outer diameter 46 mm, then turning 20 mm along the bar, then grooving and turning back, so on into diameter 10.2 mm.

| | |
|---|---|
| Operation: | Grooving and turning |
| Material: | AISI 4340 (SS 2541-03) |
| Insert-style: | N123G2-0300-0003-TF |
| Cutting speed: | 220 m/min |
| Feed grooving: | 0.15 mm/r |
| Feed turning: | 0.13 mm/r |
| Time per component: | 28 s |
| With coolant | |

Results in number of finished components and tool life in minutes:

| | |
|---|---|
| Grade A1 (invention) | 86.7 components, 40.5 min in cut |
| Grade B (prior art) | 46.7 components, 21.8 min in cut |

### Example 4

Inserts A1 and B were tested in grooving of a quenched and tempered steel. The outer diameter of the groove, Dₒ, was 178 mm, the inner diameter, Dᵢ, 172 mm and the width of the groove 3 mm.

| | |
|---|---|
| Operation: | Grooving |
| Material: | AISI 4340 (SS 2541-03) |
| Insert-style: | N123G2-0300-0003-TF |
| Cutting speed: | 210 m/min |
| Feed grooving: | 0.12 mm/r |
| Cutting depth: | 3 mm |
| Time per cycle: | 3 min (1 cycle is 30 grooves) |
| With coolant | |

Results: The tool life at a predetermined flank wear of 0.2 mm. Grade A1 was run 21.3 cycles and total time in cut was 63.9 min. The tool life of inserts B was 11.3 cycles and these were finished in 33.9 min.

### Example 5

Insert A1 and B were tested in grooving and turning of an austenitic stainless steel component. The first operation is a 2 mm deep groove from outer diameter 45 mm, then turning 20 mm along the bar, then grooving and turning back, so on into diameter 10.2 mm.

| | |
|---|---|
| Operation: | Grooving and turning |
| Material: | SANMAC 316L |
| Insert-style: | N123H2-0400-0008-TM |
| Cutting speed: | 180 m/min |
| Feed grooving: | 0.15 mm/r |
| Feed turning: | 0.15 mm/r |
| Time per component: | 27 s |
| With coolant | |

Results in number of finished components and tool life in minutes:

| | |
|---|---|
| Grade A1 (invention) | 70 components, 31.5 min in cut |
| Grade B (prior art) | 51 components, 23.3 min in cut |

### Example 6

Inserts A1 and B were tested in grooving of steel with Dₒ 159 mm, D±140 mm and width 9.5 mm.

| | |
|---|---|
| Operation: | Grooving |
| Material: | SN2039 |
| Insert-style: | N123L2-0800-RM |
| Cutting speed: | 150-130 m/min |
| Feed: | 0.3 mm/r |
| Time per component: | 90 s |
| With coolant | |

Results in number of finished components and tool life in minutes:

| | |
|---|---|
| Grade A1 (invention) | 71 components, 106.5 min in cut |
| Grade B (prior art) | 34 components, 51 min in cut |

### Example 7

Inserts A1 and B were tested in internal threading M24×1.5 length 24 mm in Steel C40, hardness 190-250 HB.

| | |
|---|---|
| Operation: | Internal threading |
| Material: | C40 |
| Insert-style: | R166.OL-16MM01-150 |
| Cutting speed: | 115 m/min |
| Number of passes: | 7 per thread |
| With coolant | |

Results in number of threads:

| | |
|---|---|
| Grade A1 (invention): | 580 threads |
| Grade B (prior art): | 430 threads |

### Example 8

Inserts A2 and B were tested in grooving of steel from Dₒ 177.9 mm to D±165.8 mm. The width of the grooves was 12.45 mm.

| | |
|---|---|
| Operation: | Grooving |
| Material: | 16MnCr5 |
| Insert-style: | N123H2-0400-0004-TF |
| Cutting speed: | 255 m/min |
| Feed: | 0.15 mm/r |
| Time per component: | 17 s |
| With coolant | |

Results in number of components and tool life in minutes at a predetermined surface finish:

| | |
|---|---|
| Grade A2 (invention): | 107 components, 30.3 min in cut |
| Grade B (prior art): | 75 components, 21.3 min in cut |

### Example 9

Inserts A2 and B were tested in parting off a steel bar from Dₒ 20 mm to centre.

| | |
|---|---|
| Operation: | Parting off |
| Material: | 42CrMo4, Hardness 320 HB |
| Insert-style: | N123G2-0300-0002-CM |
| Cutting speed: | From 100 m/min to 0 m/min |
| Feed: | 0.15 mm/r, from diam 3 mm f = 0.05 mm/r |
| Time per component: | 4 s |
| With coolant | |

Results in number of components and tool life in minutes:

| | |
|---|---|
| Grade A2 (invention): | 6200 components, 413 min in cut |
| Grade B (prior art): | 3600 components, 240 min in cut |

### Example 10

Inserts A2 and B were-tested in parting off a steel tube from Dₒ 36 mm to Dᵢ 117 mm.

| | |
|---|---|
| Operation: | Parting off tube |
| Material: | 42CD4, Hardness 300 HB |
| Insert-style: | N123G2-0300-0003-CR |
| Cutting speed: | 150 m/min |
| Feed: | 0.1 mm/r |
| Time per component: | 3.2 s |
| With coolant | |

Results in number of components and tool life in minutes:

| | |
|---|---|
| Grade A2 (invention): | 1159 components, 61.8 min in cut |
| Grade B (prior art): | 754 components, 40.2 min in cut |

### Example 11

Inserts A2 and B were tested in parting off a steel tube from Dₒ 120 mm to Dᵢ 115 mm.

| | |
|---|---|
| Operation: | Parting off tube |
| Material: | SAE1010, Hardness 110 HB |
| Insert-style: | N123G2-0300-0003-CR |
| Cutting speed: | From 226 m/min to 216 m/min |
| Feed: | 0.15 mm/r |
| Time per component: | 1.67 s |
| With coolant | |

Results in number of components and tool life in minutes:

| | |
|---|---|
| Grade A2 (invention): | 700 components, 19 min in cut |
| Grade B (prior art): | 580 components, 16 min in cut |

### Example 12

Inserts A2 and B were tested in parting off a 20 mm Inconel pin.

| | |
|---|---|
| Operation: | Parting off pin |
| Material: | Inconel 718 |
| Insert-style: | N123G2-0300-0002-CM |
| Cutting speed: | 20 m/min |
| Feed: | 0.07 to 0.03 mm/r |
| With coolant | |

Results in number of components:

| | |
|---|---|
| Grade A2 (invention): | 100 pins |
| Grade B (prior art): | 85 pins |

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Cutting tool insert comprising a substrate and a coating, wherein the substrate comprises WC, from about 7.5 to about 10.5 wt-% Co, from about 0.7 to about 1.1 wt-% Cr and from about 100 to about 300 ppm Ti, with a CW_Cr-ratio of from about 0.77 to about 0.97, and a coercivity of from about 21 to about 27 kA/m, the CW_Cr ratio being defined as
CW_Cr=(magnetic-% Co+1.13*wt-% Cr)/wt-% Co,
where magnetic-% Co is the weight percentage of magnetic Co, wt-% Cr is the weight percentage of Cr in the cemented carbide and wt-% Co is the weight percentage of Co in the cemented carbide, and,
the coating comprises two (Ti,Al)N-layers with different Al/Ti-ratios: an inner Al_{y}Ti_{1-y}N-layer with y equal from about 0.4 to about 0.67, with a thickness of from about 0.3 to about 2.5 μm, and an outer Al_{w}Ti_{1-w}N layer with w equal from about 0.15 to about 0.35, with a thickness of from about 0.5 to about 5.0 μm.

2. Cutting tool insert according to claim 1, wherein the substrate comprises from about 8.5 to about 9.5 wt-% Co.

3. Cutting tool insert according to claim 1, wherein the substrate comprises from about 0.8 to about 1.0 wt-% Cr.

4. Cutting tool insert according to claims 1, wherein the substrate comprises from about 200 to about 260 ppm Ti.

5. Cutting tool insert according to claim 1, wherein the substrate has a CW_Cr-ratio of from about 0.82 to about 0.92 and a coercivity of from about 22 to about 26 kA/m.

6. Cutting tool insert according to claim 1, wherein y equals from about 0.45 to about 0.60 and w equal from about 0.20 to about 0.30.

7. Cutting tool insert according to claim 1, wherein the inner Al_{y}Ti_{1-y}N-layer has a thickness of from about 0.5 to about 2.0 μm and the outer Al_{w}Ti_{1-w}N layer has a thickness of from about 1.0 to about 4.0 μm.

8. Cutting tool insert according to claim 1, wherein Ti in the substrate is partly replaced by Ta to a weight ratio Ti/Ta of more than or equal to about 0.8, but less than or equal to about 1.7

9. Cutting tool insert according to claim 1, wherein the inner layer is an aperiodic lamella coating of alternating layers of Al_{z}Ti_{1-z}N and AlᵥTi₁₋ᵥN where z equals from about 0.55 to about 0.70, and v equals from about 0.35 to about 0.53, with a thickness of each individual layer from about 0.1 to about 20 nm, and/or,
the outer layer is an aperiodic lamella coating with alternating layers of AlₘTi₁₋ₘN, AlₙTi₁₋ₙN and AlₖTi₁₋ₖN where m equals from about 0 to about 0.2, n equals from about 0.35 to about 0.53, k equals from about 0.55 to about 0.70, with a thickness of each individual layer of from about 0.1 to about 20 nm.

10. Cutting tool insert according to claim 9, wherein z equals from about 0.6 to about 0.67 and v equals from about 0.40 to about 0.50.

11. Cutting tool insert according to claim 9, wherein m equals from about 0 to about 0.1, n equals from about 0.40 to about 0.50, and k equals from about 0.6 to about 0.67.

12. Cutting tool insert according to claim 9, wherein the inner layer and the outer layer are aperiodic lamella coatings, wherein the thickness of each individual layer is from about 1 to about 10 nm.

13. Cutting tool insert according to claim 1, comprising an innermost adhesion layer of TiN with a thickness of from about 0.05 to about 0.2 μm.

14. Method of making a coated cutting tool insert comprising a cemented carbide substrate and a coating, comprising the following steps:
providing a substrate using conventional powder metallurgical techniques milling, pressing and sintering, of WC, from about 7.5 to about 10.5 wt-% Co, from about 0.7 t about 1.1 wt-% Cr, and from about 100 to about 300 ppm Ti, with a CW_Cr-ratio of from about 0.77 to about 0.97, and a coercivity of from about 21 to about 27 kA/m, the CW_Cr ratio being defined as
CW_Cr=(magnetic-% Co+1.13*wt-% Cr)/wt-% Co
where magnetic-% Co is the weight percentage of magnetic Co, wt-% Cr is the weight percentage of Cr and wt-% Co is the weight percentage of Co in the cemented carbide, and,
depositing using cathodic arc evaporation or magnetron sputtering a coating comprising two (Ti,Al)N-layers with different Al/Ti-ratios: an inner Al_{y}Ti_{1-y}N-layer with y equals from about 0.4 to about 0.67, with a thickness of from about 0.3 to about 2.5 μm and an outer Al_{w}Ti_{1-w}N layer with w equals from about 0.15 to about 0.35, with a thickness of from about 0.5 to about 5.0 μm.

15. Method according to claim 14, wherein the substrate comprises from about 8.5 to about 9.5 wt-% Co.

16. Method according to claim 14, wherein the substrate comprises from about 0.8 to about 1.0 wt-% Cr.

17. Method according to claim 14, wherein the substrate comprises from about 200 to about 260 ppm Ti.

18. Method according to claim 14, wherein the substrate has a CW_Cr-ratio of from about 0.82 to about 0.92 and a coercivity of from about 22 to about 26 kA/m.

19. Method according to claim 14, wherein for the inner Al_{y}Ti_{1-y}N-layer, y equals from about 0.45 to about 0.60, and for the outer Al_{w}Ti_{1-w}N layer, w equals from about 0.20 to about 0.30.

20. Method according to claim 14, wherein the inner Al_{y}Ti_{1-y}N-layer has a thickness of from about 0.5 to about 2.0 μm and the outer Al_{w}Ti_{1-w}N layer has a thickness of from about 1.0 to about 4.0 μm.

21. Method according to claim 14, wherein Ti in the substrate is partly replaced by Ta to a weight ratio Ti/Ta of equal to or more than about 0.8, but equal to or less than about 1.7.

22. Method according to claim 14, wherein the inner layer is an aperiodic lamella coating of alternating layers of Al_{z}Ti_{1-z}N and AlᵥTi₁₋ᵥN where z equals from about 0.55 to about 0.70 and v equals from about 0.35 to about 0.53, with a thickness of each individual layer being from about 0.1 to about 20 nm, and/or the outer layer is an aperiodic lamella coating with alternating layers of AlₘTi₁₋ₘN, AlₙTi₁₋ₙN and AlₖTi₁₋ₖN where m equals from about 0 to about 0.2, n equals from about 0.35 to about 0.53, k equals from about 0.55 to about 0.70, with a thickness of each individual layer of from about 0.1 to about 20 nm.

23. Method according to claim 22, wherein z equals from about 0.6 to about 0.67 and v equals from about 0.40 to about 0.50.

24. Method according to claim 22, wherein m equals from about 0 to about 0.1, n equals from about 0.40 to about 0.50, and k equals from about 0.6 to about 0.67.

25. Method of parting, grooving and threading in steel and stainless steel under wet conditions at a cutting speed of from about 30 to about 400 m/min and a feed of from about 0.05 to about 0.6 mm/rev, using a cutting tool insert comprising a substrate and a coating, wherein the substrate is WC, from about 7.5 to about 10.5 wt-% Co, from about 0.7 to about 1.1 wt-% Cr and from about 100 to about 300 ppm Ti, with a CW_Cr-ratio of from about 0.77 to about 0.97, and a coercivity of from about 21 to about 27 kA/m, the CW_Cr ratio being defined as
CW_Cr=(magnetic-% Co+1.13*wt-% Cr)/wt-% Co,
where magnetic-% Co is the weight percentage of magnetic Co, wt-% Cr is the weight percentage of Cr in the cemented carbide and wt-% Co is the weight percentage of Co in the cemented carbide, and,
the coating comprises two (Ti,Al)N-layers with different Al/Ti-ratios: an inner Al_{y}Ti_{1-y}N-layer with y equals from about 0.4 to about 0.67, with a thickness of from about 0.3 to about 2.5 μm, and an outer Al_{w}Ti_{1-w}N layer with w equals from about 0.15 to about 0.35, with a thickness of from about 0.5 to about 5.0 μm.
